(19) United States
(12) Patent Application Publication
(10) Pub. No.: US 2005/0250483 A1
(43) Pub. Date: Nov. 10, 2005

(54) Caller look-up system

(76) Inventor: Dale W. Malik, Dunwoody, GA (US)

Correspondence Address: THOMAS, KAYDEN, HORSTEMEYER & RISLEY, LLP/;BELLSOUTH I.P. CORP, 100 GALLERIA PARKWAY, SUITE 1750, ATLANTA, GA, 30339, US

(21) Appl. No.: 10/841,111

(22) Filed: May 7, 2004

(51) Int. Cl. H04M 3/42

(52) U.S. Cl. 455/415; 455/466; 709/219

(57) ABSTRACT

Providing a user of a mobile communication device with directory information for a missed call is disclosed. A router is adapted to receive a query message for directory information for a given telephone number from a mobile communication device. The router determines whether the given telephone number is associated with the first telephony system or is associated with a second telephony network. A server and a gateway are connected to the router. The server is in communication with a database having directory information associated with the first telephony network stored therein. The gateway is in communication with the second telephony network. If the given telephone number is associated with the first telephony network, the router provides the server with the query message. If given telephone number is associated with the second telephony network, the router provides the gateway with the query message. The mobile communication device includes logic embodied in a computer readable medium for generating a query message, the query message including a look-up indicator associated with a missed message; and logic embodied in a computer readable medium for parsing a response message. The response message includes directory information related to the missed message.

### TECHNICAL FIELD

The present disclosure is generally related to mobile communication devices and, more particularly, is related to a system and method for providing directory information to a mobile communication device.

### BACKGROUND

Today, there exists many telephony networks that provide mobile communication services. A user of such a telephony network can take a mobile communication device such as a cell phone with him or her and receive and transmit calls and messages so long as they are within their network. Typically, subscribers of a telephony network will miss some calls for reasons such as they are out of their telephony network; their mobile communication device is turned off; or they simply don't answer the call. Today, mobile communication devices typically include a call log, which is a log of both answered and unanswered calls. The user of the mobile communication device may access the log to see what calls have been answered and/or to see what calls he or she missed. The calls are normally displayed to the user as the number of the telephone that dialed the mobile communication device. Quite often, the user may not recognize the telephone numbers of the calls. Thus, what is sought is a method and system for providing users of the mobile communication devices with additional information related to answered or unanswered calls.

### SUMMARY OF THE DISCLOSURE

Embodiments, among others, of the present disclosure provide a user of a mobile communication device with directory information for a missed call.

Briefly described, in architecture, one embodiment of the system, among others, can be implemented as follows. A router is adapted to receive a query message for directory information for a given telephone number from a mobile communication device. The router determines whether the given telephone number is associated with the first telephony system or is associated with a second telephony network. A server and a gateway are connected to the router. The server is in communication with a database having directory information associated with the first telephony network stored therein. The gateway is in communication with the second telephony network. If the given telephone number is associated with the first telephony network, the router provides the server with the query message. If given telephone number is associated with the second telephony network, the router provides the gateway with the query message.

Briefly described, in architecture, one embodiment of the apparatus, among others, can be implemented as follows. A mobile communication device includes logic embodied in a computer readable medium for generating a query message, the query message including a look-up indicator associated with a missed message; and logic embodied in a computer readable medium for parsing a response message. The response message includes directory information related to the missed message.

Embodiments, among others, of the present disclosure can also be viewed as providing methods for providing a mobile communication device with directory information for a missed call from a given telephone number. In this regard, one embodiment of such a method, among others, can be broadly summarized by the following steps: receiving from the mobile communication device a query message having an indicator associated with the given telephone number; determining the directory information for the given telephone number; and transmitting a response message to the mobile communication device, the response message including the directory information.

Other systems, methods, features, and advantages of the present disclosure will be or become apparent to one with skill in the art upon examination of the following drawings and detailed description. It is intended that all such additional systems, methods, features, and advantages be included within this description and be within the scope of the present disclosure.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram of a mobile communication system having a first service provider, a second service provider, and a mobile communication device.

FIG. 2 is a block diagram of the first service provider of FIG. 1.

FIG. 3 is a block diagram of the second service provider of FIG. 1.

FIG. 4 is a block diagram of the mobile communication device of FIG. 1.

FIG. 5 is a block diagram of a controller of the mobile communication device.

FIG. 6 is an illustrative menu provided to the user of the mobile communication device.

FIG. 7 is an illustrative menu provided to the user of the mobile communication device.

FIG. 8 is an illustrative menu provided to the user of the mobile communication device.

FIG. 9 is a block diagram of a message template.

FIG. 10 is a block diagram of a query message.

FIG. 11 is a block diagram of a response message.

FIG. 12 is an illustration of directory information displayed to the user of the mobile communication device.

FIG. 13 is a block diagram of a telephone book stored in the mobile communication device

FIG. 14 is a flow chart of steps taken at the mobile communication device related to getting and displaying directory information

FIG. 15 is a flow chart of steps taken at a directory look-up service provider related to providing directory information.

### DETAILED DESCRIPTION OF THE PREFERRED EMBODIMENT

Any process descriptions or blocks in flow charts should be understood as representing modules, segments, or portions of code which include one or more executable instructions for implementing specific logical functions or steps in the process, and alternate implementations are included within the scope of the preferred embodiment of the present disclosure in which functions may be executed out of order from that shown or discussed, including substantially concurrently or in reverse order, depending on the functionality involved, as would be understood by those reasonably skilled in the art of the present invention.

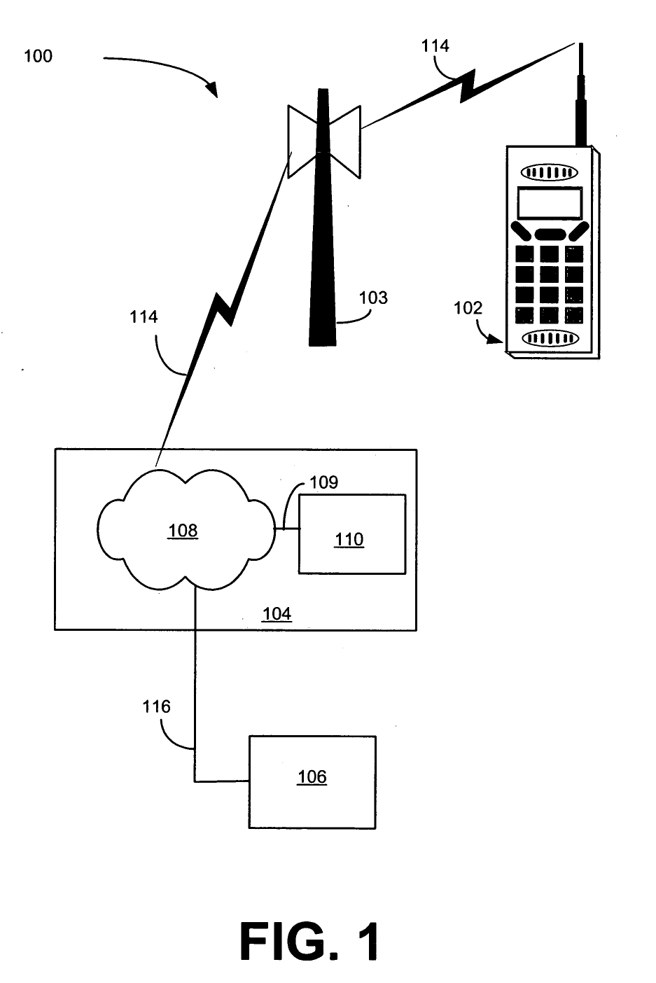

FIG. 1 is a block diagram of a mobile communication system 100. The mobile communication system 100 includes a mobile communication device 102 and a service provider 104. The mobile communication device 102 and service provider 104 communicate using signals that are carried over a wireless communication link 114. The signals carried over the wireless communication link 114 are relayed by one or more base stations 103. In some embodiments, the base stations 103 are in communication with the service provider 104 via a high bandwidth wired/optical communication link.

The service provider 104 is in communication with entities such as a second service provider 106 via communication link 116. The communication link 116 can be wired, optical, wireless, or other communication links known to those skilled in the art. Communication between service providers 104 and 106 enables subscribers of one of the service providers to communicate with subscribers of the other service provider. The service provider 106 also provides directory information.

The service provider 104 includes an short message service (SMS) network 108 and one or more central offices 110. The SMS network 108 and central office 110 communicate over a communication link 109. Those skilled in the art are familiar with SMS networks, which provide messaging services to and from the communication device 102, and therefore, the SMS network shall not be described in detail. SMS messages are generally short messages that are in the range of 120-200 characters. Although this disclosure describes communication between the mobile communication device 102 and the service provider 104 in terms of SMS messages, this was done for the sake of clarity and is a non-limiting embodiment.

The service providers 104 and 106 each include various databases, computer systems, etc., for among other things, billing subscribers, processing/routing calls and messages, providing services such as, but not limited to, call number lookup.

Frequently, a user of the mobile communication device 102 receives calls from callers that the user does not answer. The telephone numbers of the unanswered calls are normally stored in a call log in a memory of the mobile communication device 102. The mobile communication device 102 also includes a telephone book that associates “names” with telephone numbers. Typically, if a call, answered or unanswered, came from a telephone whose number is listed in the telephone book of the mobile communication device 102, then the associated name is listed in the call log. On the other hand, if a call, answered or unanswered, came from a telephone whose number is not listed in the telephone book, then the telephone number for that telephone is listed in the call log. The user of the mobile communication device 102 may access the call log and select a telephone number for one of the calls in the call log. The user may send a query message, which is described in detail hereinbelow and which includes the selected telephone number, to his service provider 104 requesting the name that is associated with the telephone number. In one preferred embodiment, the query message is formatted according to an SMS protocol. Those skilled in the art will understand that describing messages such as query message in terms of SMS messages is for the sake of clarity and is a non-limiting example.

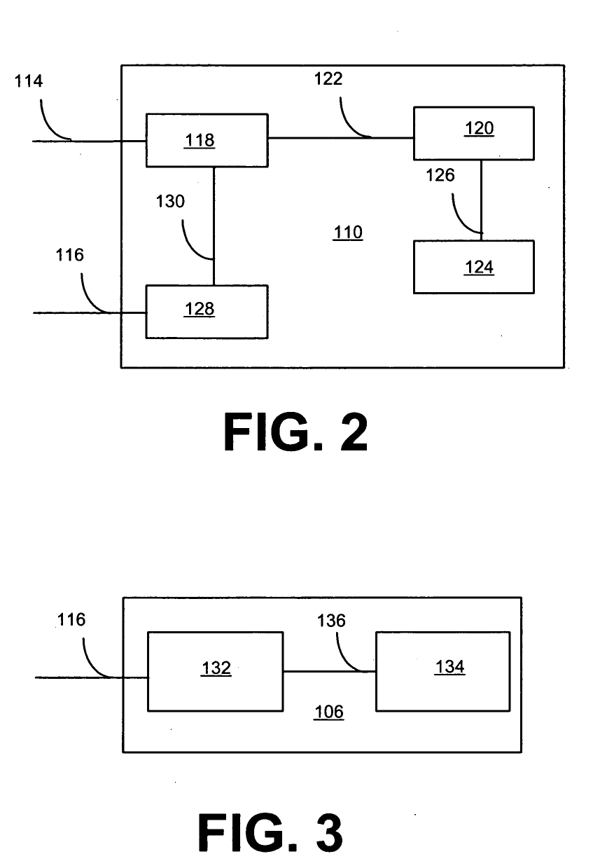

FIG. 2 is a block diagram illustrating additional selected components of the central office 110. The central office 110 includes at least a router 118 and a server 120, which are coupled together via a communication link 122. Among other things, the router 118 receives SMS messages from the mobile communication device 102 and routes the SMS messages. The central office 110 also includes a database 124 that is connected to the SMS server 120 by a communication link 126. The database 124 includes names and telephone numbers of subscribers of the service provider 102. In one preferred embodiment, the database 124 is a “structured query language” (SQL) capable database that can provide information in response to SQL calls, and in another preferred embodiment, the database 124 is adapted to be responsive to Light Directory Access Protocol (LDAP) queries.

The central office 110 also includes an e-mail gateway 128 that is coupled to the router 118 by a communication link 130. The e-mail gateway 128 is adapted to receive SMS messages from the router 118 and transmit e-mail messages over communication link 116. As those skilled in the art would understand, e-mail messages are only one form of messages that can transmitted over communication link 116, and in other preferred embodiments, other types of messages are received and transmitted over communication link 116.

The router 118 includes a look-up table for telephone numbers provided by the service provider 104. When the router 118 receives a query message from the mobile communication device 102, the router 118 determines whether the query message is an in-network or off-network message using the look-up tables. For the purposes of this disclosure, an in-network message is one in which the telephone that dialed the missed call corresponds to a subscriber of the service provider 102. Whereas, an off-network query message is one where the telephone that dialed the missed call does not correspond to a subscriber of the service provider 102, and an off-network service provider is defined as a service provider other than the service provider 104. It is important to note that the mobile communication device 102 sends query messages, and that it is the router that filters the received query messages into in-network and off-network query messages, i.e., there is no difference in the format between an off-network and in-network query message.

When the router 118 receives a query message that is an in-network query message, the router 118 provides the query message to the SMS server 120. When the router 118 receives an off-network query message, the router 118 sends the query message to the e-mail gateway 128.

As those skilled in the art would understand, the service provider 104 can respond to query messages based upon different business models. For example, directory information look-up can be a premium service, bundled with selected services, a per use service, charged on a graduated fee basis, etc. The router 118 provides a billing system (not shown) of the service provider with billing information related to query messages from the mobile communication device 102. Typically, the billing information from the router to the billing system includes information regarding whether or not the query message was an off-network or in-network query message. The billing system then uses the information from the router 118 to bill or not bill the user of the mobile communication device 102.

When the SMS server 120 receives a query message, the server 120 parses the query message to find the telephone number included in the query message. The server 120 then queries database 124. Typically, the query from the server 120 to the database 124 is performed using an SQL call or an LDAP call that includes the telephone number. In response to receiving the SQL or LDAP call from the server 120, the database 124 sends the name that is associated with the telephone number to the server 120. The server 120 then generates a response message, which is described in detail hereinbelow, that includes a field for the requested name. The response message is sent from the server 120 to the router 118 and then to the mobile communication device 102.

When the query message is an off-network query, then the router 118 sends the message to the e-mail gateway 128. Among other things, the e-mail gateway 128 receives SMS messages from the router 118 and reformats the messages into e-mail messages. The e-mail gateway 128 includes look-up tables that the e-mail gateway 128 uses for, among other things, determining the e-mail address of the off-network service provider associated with the selected telephone number included in the off-network query message. When the e-mail gateway receives an SMS message, the e-mail gateway determines an address for a recipient, i.e., the off-network service provider associated with the selected telephone number included in the off-network query message. The e-mail gateway 128 then sends an e-mail message to the recipient over communication link 116.

The e-mail gateway 128 also receives e-mail messages from other service providers such as service provider 106 and reformats the e-mail messages into SMS messages, which are then sent to the router 118. As will be described in detail hereinbelow, the messages from other service providers include names associated with telephone numbers selected by the user of the mobile communication device 102.

FIG. 3 is a block diagram illustrating selected components of the off-network service provider 106. The service provider 106 includes an e-mail response system 132 connected to a database 134 via a communication link 136. The e-mail response system 132 receives e-mails from the e-mail gateway 128 via communication link 116. When the e-mail response system 132 receives an e-mail, the e-mail response system 132 parses the e-mail to get the telephone number that was selected by the user of the mobile communication device 102. The e-mail response system 132 then sends a query, which is normally formatted in a protocol such as, but not limited to, signal system 7 (SS7) to the database 134. The database 134 provides the name that is associated with the telephone number to the e-mail response system 132. The e-mail response system 132 then sends a response e-mail message that includes the name to the e-mail gateway 128.

As those skilled in the art will recognize, if the telephone number that the subscriber selected was unpublished, then the queried database, either database 124 or database 134 does not provide that name. Instead, the appropriate database provides an indication that the name is unpublished. In either case, the user of the mobile communication device 102 would receive a response message indicating that the name was “unpublished,” or some other indication that the telephone number was unpublished/unlisted/unavailable.

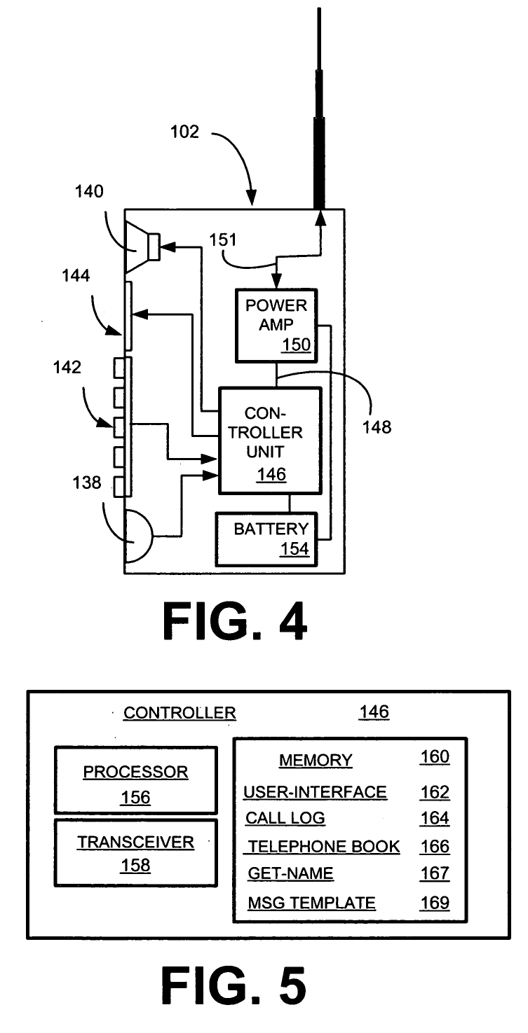

FIG. 4 is a block diagram of selected components of the mobile communication device 102. The mobile communication device 102 includes a microphone 138, a speaker 140, keys 142, and a display device 144. The microphone 138 converts audio energy into electrical signals and provides the electrical signals to a controller unit 146. The speaker 140 converts electrical signals from the controller unit 146 into audio signals. The keys 142 are actuated by the user of the mobile communication device 102 and enable the user to provide input to the controller 146. The user may also use the keys to, among other things, enter telephone numbers, write text of messages, enter names and control and select menu options.

The display device 144 is typically a liquid crystal display (LCD) or similar display. The display device 144 receives electrical signals from the controller unit 146 and provides graphical and textual information to the user.

The mobile communication device 102 also includes a power source 154. Non-limiting examples of power source 154 include conventional batteries, fuel cells and solar energy panels, and rechargeable batteries. The power source 154 provides electrical energy to the controller unit 146 and to a power amplifier 150.

Among other things, the controller unit 146 receives input from the keys 142, and from the microphone 138. The controller unit 146 also receives input from a power amplifier 150 via connection 148. The controller unit 146 provides output to the display device 144, the speaker 140, and the power amplifier 150. The controller unit also provides communication signals to the power amplifier 150 and receives signals from the power amplifier 150 via the connection 148.

The power amplifier 150 amplifies communication signals from the controller unit 146 and provides the amplified communication signals to an antenna 152 via connection 151. The antenna 152 also receives signals from the base station 103 and provides the signals to the controller unit 146 via the power amplifier 150.

FIG. 5 is a simplified block diagram of select components of the controller unit 146. The controller unit 146 includes a processor 156, a transceiver 158, and a memory 160. The transceiver 158 receives signals from the microphone 138. Typically, the transceiver 158 includes an analog-to-digital converter that converts the signals from the microphone 138 into digital signals. The digital signals are then provided to the power amplifier 150. The transceiver 158 also normally includes a digital-to-analog converter that receives digital signals from the base station 103 via the power amplifier 150 and converts the digital signals into analog signals, which are then provided to the speaker 140.

The memory 160 includes a user interface module 162, a call log 164, a telephone book 166, a get-name module 167, and a message template 169. The call log 164 includes tables of telephone numbers and other information. Generally the call log 164 includes, among other things, telephone numbers for dialed calls, telephone numbers of received calls, and telephone numbers of unanswered calls. Among other things, the get-name module 167 includes logic for partially filing in the message template 169, for parsing a received message, and for saving directory information. The telephone book 166 is a table of telephone numbers and names.

Preferred embodiments can be implemented in hardware, software, firmware, or a combination thereof. In one preferred embodiment, the e-mail distribution/regulatory logic is implemented in software or firmware that is stored in a memory and that is executed by a suitable instruction execution system. If implemented in hardware, as in an alternative embodiment, the e-mail distribution/regulatory logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The processor 156 implements the user interface module 162 to provide, user interface functions to the user of the mobile communication device 102. In alternative embodiments, user interface functionality can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

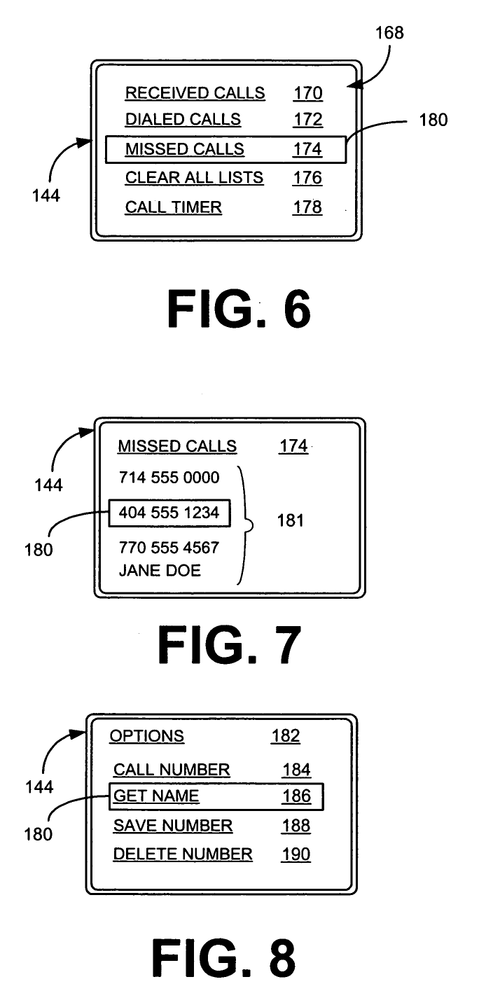

FIG. 6 is a block diagram of a menu 168 that is displayed in the display device 144 by the processor 156 implementing the user interface module 162. The menu 168 is for illustrative purposes only, and in alternative embodiments, the menu can contain more items, less items, different items, and/or display the items in different order. The user actuates the menu 168 by providing the proper input to the controller 146 via keys 144. The menu 168 includes items such as, but not limited to, received calls 170, dialed calls 172, missed calls 174, clear all list 176, and call timer 178. Using keys 142, the user can move a highlighter 180 over any of the items in the menu 168. Once an item is highlighted by the highlighter 180, the user may use keys 142 to select the highlighted item.

Received calls 170 includes a list of calls that have been received and answered at the mobile communication device 102. Dialed calls 172 includes a list of out-going calls from the mobile communication device 102. Missed calls 174 includes a list of calls that have been received but were unanswered at the communication device 102. Clear all list 176, enables the user to clear the lists in 170, 172 and 174. The call timer 178 indicates the amount of time that the user has used the mobile communication device since the last time that the timer was wiped clean. The timer can be wiped clean by the clear all list 176.

FIG. 7 illustrates a list 181 of missed calls displayed in the display device 144. The list 181 is displayed when the user selects missed calls 174. In this example, the list 181 includes the three most recently missed calls. In other embodiments, more or fewer calls can be displayed at one time. Using keys 142, the user uses the highlighter 180 to select a number. The list 181 includes telephone numbers and names such as Jane Doe. Jane Doe's name appears instead of a telephone number because the telephone book 166 includes Jane Doe's name and telephone number and because the missed call originated from the telephone having that telephone number.

FIG. 8 illustrates an exemplary options menu 182. Options provided to the user via options menu 182 include call number 184, get name 186, save number 188, and delete number 190. When the user selects call number 184, the number that was selected in FIG. 7 is called. When the user selects save number 188, the number that the user selected in FIG. 7 is saved. When the user selects delete number 190, the number that was selected in FIG. 7 is deleted. When the user selects get name 186, the mobile communication device 102 requests the name of a person/business/organization that is associated with the telephone number selected in FIG. 7. The request is made via a query message that is transmitted to the service provider 104.

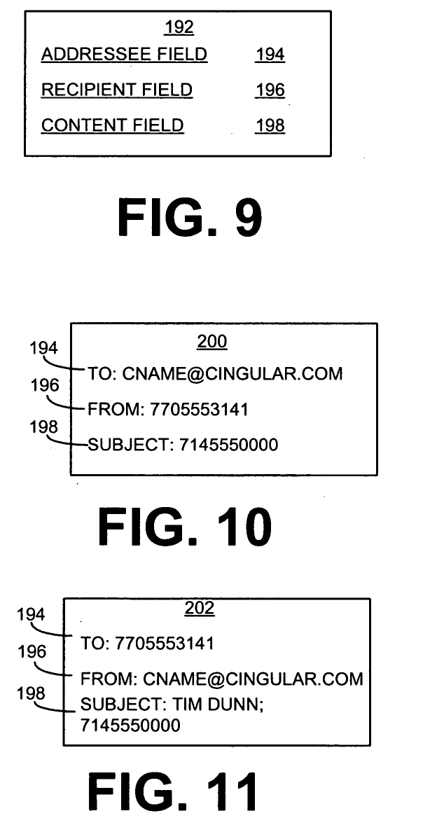

FIG. 9 illustrates the exemplary message template 169, which is stored in memory 160 and which is used for, among other things, communicating between the mobile communication device 102 and base station 103 and service providers and others. For the purposes of illustration, the message template 169 is described as an SMS message. The message template 169 includes an address field 194, a sender field 196 and a content field 198.

FIG. 10 illustrates an exemplary query message 200. When the user selects “get name” 184, the processor 156 generates a copy of the message template 169 and populates the fields 194, 196 and 198, of the query message 200. The address field 194 is populated with a unique address such as “user_name@ domainname.” In this embodiment, the “user_name” is used to define a particular service offered by the recipient of the query message 200. The “domainname” in the address corresponds to a name found by a domain name server. In the exemplary query message illustrated in FIG. 10, the call look-up service, which is provided by the service provider 104, is called “cname”, and the service provider 104 is “Cingular”®. In one preferred embodiment, the “user_name” is populated by an unusable telephone number such as “9999999999” and the “domainname” is associated with the service provider 104.

The processor 156 populates the sender field 196 with an identifier of the mobile communication device 102. Typically, the identifier of the mobile communication device 102 is the telephone number of the mobile communication device, however, other identifiers can also be used. The identifier for the sender is unique to the mobile communication device 102 at least within the network established by the service provider 104.

The processor 156 populates the content field 198 with the telephone number that was selected by the user in FIG. 7. In an alternative embodiment, a look-up indicator for the selected telephone number is included in the content field 198. In that case, the service provider 104 uses the look-up indicator to determine the telephone number that was selected in FIG. 7.

FIG. 11 illustrates an exemplary response message 202. As with the query message 200, the response message 202 conforms to a predetermined message format, such as SMS. The response message 202 is addressed to the mobile communication device 102, and in this case, the address is the telephone number of the mobile communication device 102. The sender field 196 of the response message 202 is populated with an address that identifies the message as being a response message. In this example, any message received by the mobile communication device 102 from the sender “cname@ cingular.com”® is a response message. In another embodiment, the sender field 196 is populated telephone#@domainname, where “telephone#” is an unusable telephone number.

The content field 198 of the response message 202 includes the name that was requested and the telephone number. If the requested telephone number was unlisted, then the content field 198 would indicate that the number was unlisted.

When the mobile communication device 102 receives a response message 202, the processor 156 reads and processes the message. The processor 156 identifies the message as being a response message using the information in the sender field 196. The content of the response message is formatted such that the processor 156 can read the content field 198 and parse the information contained therein. The content is parsed such that the processor 156 can read the telephone number and the “name” associated with the telephone number, or if the response message 202 indicated that the telephone number was unlisted, then the content is parsed such that the processor can read that the telephone number was unlisted.

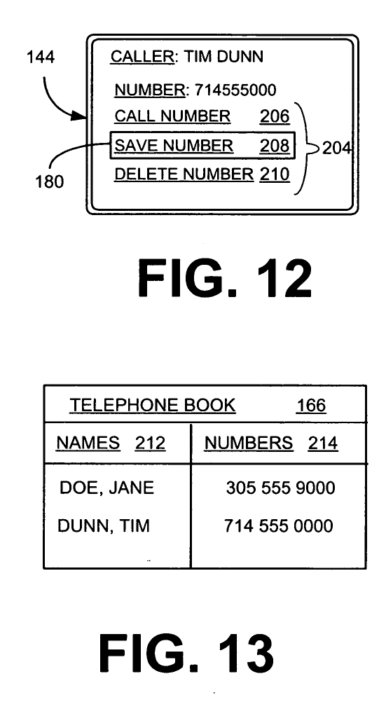

FIG. 12 illustrates the display device 144 when a response message 202 has been received and processed by the processor 156. The user is presented with an options menu 204, which includes call number 206, save number 208 and delete number 210. The user can select any of the options 206, 208 and 210, using keys 144 to control the highlighter 180. If the user selects call 206, then the telephone number selected in FIG. 7 is called. However, if the user selects save 208, then the name and telephone number received in the response message 202 is saved in the telephone book 166. The user may also select delete 210, which deletes the telephone number that was selected in FIG. 7. In one preferred embodiment, the name and telephone number received in the response message 202 are automatically saved in the telephone book 166.

FIG. 13 illustrates exemplary listings in the telephone book 166. The telephone book 166 includes names 212 and telephone numbers 214. When the user selects the “save” option 208, the telephone number that the user selected in FIG. 7 and the name associated therewith are stored in the telephone book 166.

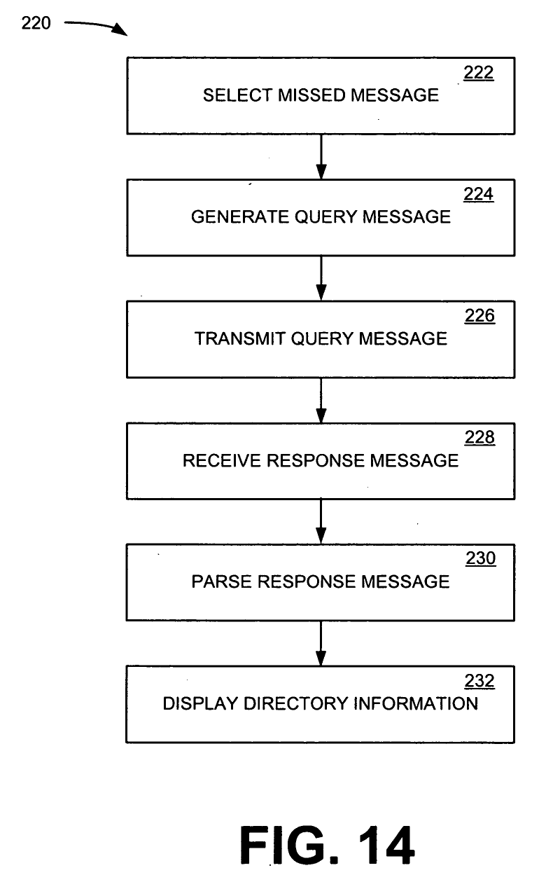

Exemplary steps 220, which are illustrated in FIG. 14, are implemented at the mobile communication device 102. In step 222, the user of the mobile communication device 102 reviews his or her call log 164 and selects from the call log 164 a missed call 174.

In step 224, the user selects “get name” 186 for the selected missed call. Responsive to the selection of “get name”, the mobile communication device 102 generates a query message 200. The query message 200 is addressed to a directory look-up provider such as the service provider 106 that responds to query messages. The query message includes a sender identifier such as the telephone number of the mobile communication device 102 and includes a look-up indicator, which is associated with the missed call selected by the user. In step 226, the query message is sent to the directory look-up service provider.

In step 228, responsive to having sent the query message 200, the mobile communication device 102 receives a response message 202. The response message 202 includes a sender field 196 that identifies the response message as having come from the directory look-up service provider and a subject field 198.

In step 230, the mobile communication 102 reads the sender field 196 and determines that the response message 202 is an actual response message as opposed to other messages that the mobile communication device can also receive. The content of the subject field 198 of the response message 202 is in a predetermined format, which enables the mobile communication device 102 to parse the content therein.

In step 232, the mobile communication device 102 displays available directory look-up information to the user of the mobile communication device 102. The display directory information includes the name associated with the telephone number that made the missed call, if that telephone number is not unlisted. However, if that telephone number is unlisted, then the displayed information is something to the effect “unlisted”, “unavailable”, “unpublished”, etc.

As previously described hereinabove, the user of the mobile communication device 102 can then choose various options such as, but not limited to, saving the displayed name in the telephone book of the mobile communication device 102 and/or returning the missed call.

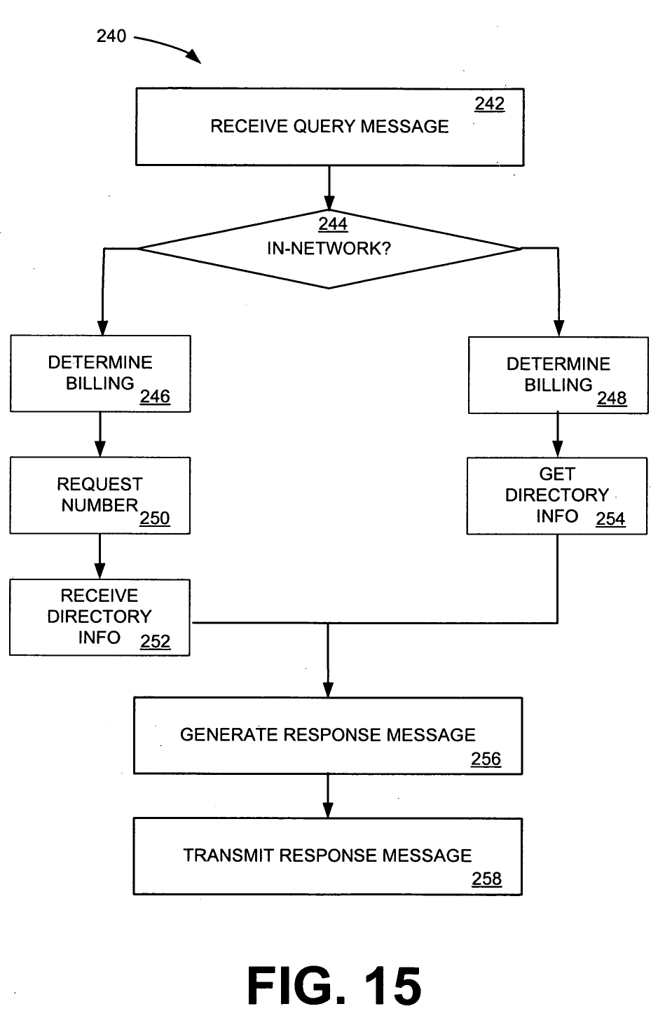

Exemplary steps 240, which are illustrated in FIG. 15, are implemented by a directory look-up service provider such as the service provider 106. In step 242, the directory look-up service provider receives a query message 200.

The query message includes a look-up indicator such as when the missed call was made that is associated with the missed call or the telephone number that is associated with the missed call. If necessary, the directory look-up service provider uses the look-up indicator to determine the telephone number of the missed call.

In step 244, the directory look-up service provider determines whether the query message is for an off-network or in-network telephone number. In steps 246 and 248 the directory look-up service provider determines billing charges for the query message. The billing charges can depend upon whether the query is for an off-network telephone number or in-network telephone number, the number of directory information look-up request by the mobile communication device 102, whether the mobile communication device is given free directory information look-up, etc.

In an alternative embodiment, the directory look-up service provider sends the mobile communication device 102 a message informing the user of how much he or she will be charged for looking up the requested telephone number. The user may then send a message that confirms that he or she accepts the charge. Once the directory look-up service provider has received the confirmation message from the user, the process continues. Otherwise, the directory look-up service provider ignores the query message.

In step 250, responsive to the query message being an off-network look-up, the directory look-up service provider requests caller look-up from another service provider. The other service provider has a database that associates the telephone number of the missed call with the registered user of the telephone number. In one preferred embodiment, the directory look-up service provider sends the other service provider an e-mail requesting the name of the registered user. The other service provider looks-up the registered user's name and provides the directory information in a return e-mail.

In step 252, the directory look-up service provider receives the directory information from the other service provider.

In step 254, the directory look-up service provider uses its own database to determine directory information for the telephone number of the missed call.

If the query message was an in-network query message, then in step 256, the directory look-up service provider generates a response message that includes the directory information, and in step 258, the response message is transmitted to the mobile communication device 102.

Any process descriptions or blocks in flow charts should be understood as representing modules, segments, or portions of code which include one or more executable instructions for implementing specific logical functions or steps in the process, and alternate implementations are included within the scope of the preferred embodiment of the present disclosure in which functions may be executed out of order from that shown or discussed, including substantially concurrently or in reverse order, depending on the functionality involved, as would be understood by those reasonably skilled in the art of the present invention.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. For example, in one preferred embodiment, the service provider 104 requests directory information for all calls that have been place to the mobile communication device 102 over a given period of time. The directory information is provided to the mobile communication device 102 but is unviewable until the user of the mobile communication device elects to view it using a special key or menu option. Once the user selects to view the directory information, the mobile communication device sends a message to the service provider 104 so that the user can be properly billed. All such modifications and variations are intended to be included herein within the scope of this disclosure and the present disclosure and protected by the following claims.

1. A method of providing a mobile communication device with directory information for a missed call from a given telephone number, the method comprising the steps of:
receiving from the mobile communication device a query message having an indicator associated with the given telephone number;
determining the directory information for the given telephone number; and
transmitting a response message to the mobile communication device, the response message including the directory information.

2. The method of claim 1, further including the steps of:
determining whether the given number is associated with a first telephony network;
responsive to determining that the given number is not associated with the first telephony network, requesting off-network directory information from a database associated with a second telephony network;
responsive to determining that the given number is not associated with the first telephony network, charging the mobile communication device for the off-network directory information; and
receiving the off-network directory information, wherein the off-network information directory information is included in the response message.

3. The method of claim 1, wherein the step of determining includes querying a database using the given telephone number.

4. The method of claim 1, wherein the query message conforms to a Short Message Service (SMS) protocol, and the response message conforms to a Short Message Service (SMS) protocol.

5. The method of claim 1, further including the step of:
using the indicator associated with the given telephone number to determine the given telephone number.

6. The method of claim 1, further including the step of:
charging the mobile communication device for determining the directory information.

7. A method of providing a user of a mobile communication device with directory information for a missed call from a given telephone number, the method comprising the steps of:
transmitting a query message having an indicator associated with the given telephone number therein;
receiving a second message having the directory information therein; and
displaying to the user at least a portion of the directory information.

8. The method of claim 7, further including the step of:
selecting the given telephone number from a log of received calls.

9. The method of claim 7, further including the step of:
storing the directory information in a memory; and
associating at least a portion of the directory information with the given telephone number.

10. The method of claim 7, wherein the query message conforms to a Short Message Service (SMS) protocol, and the second message conforms to a Short Message Service (SMS) protocol.

11. The method of claim 7, further including the steps of:
receiving user input; and
responsive to the user input, automatically populating a plurality of fields included in the query message, wherein the plurality of fields includes a content field that carries the indicator, a recipient field that is associated with a directory look-up provider, and a sender field that carries information associated with the mobile communication device.

12. The method of claim 7, further including the steps of:
determining that the second message is a response message; and
responsive to the second message being a response message; parsing the response message, wherein the directory information included therein includes at least a portion of a name associated with the given telephone number.

13. The method of claim 7, further including the steps of:
providing the user with a menu having a plurality of options including a save directory information option and a call-back option;
receiving user-input, wherein the user-input corresponds to a given option;
responsive to the user-input corresponding to the save directory information option, saving at least a portion of the directory information in the memory of the mobile communication device; and
responsive to the user-input corresponding to the call-back option, dialing the given telephone number.

14. A system for providing directory information to a user of a mobile communication device for a missed call associated a given telephone number, wherein the mobile communication device is associated with a first telephony network, the system comprising:
a router adapted to receive a query message from the mobile communication device, wherein responsive to the router receiving the query message the router determines whether the given telephone number is associated with the first telephony system or is associated with a second telephony network;
a server connected to the router, the server in communication with a database having directory information associated with the first telephony network stored therein;
a gateway in communication with the router and in communication with the second telephony network; and
wherein responsive to the given telephone number being associated with the first telephony network, the router provides the server with the query message, and wherein responsive to the given telephone number being associated with the second telephony network, the router provides the gateway with the query message.

15. The system of claim 14, wherein the gateway receives the query message from the router and sends an email message to a directory look-up service provider associated with the second telephony system requesting the directory information of the given telephone number, and wherein the gateway receives the directory information of the given telephone number and provides the directory information to the mobile communication device via the router.

16. The system of claim 14, wherein the server receives the query message from the router and parses the query message to find a key and queries the database using the key, and responsive to the query, the database provides the server with the directory information.

17. The system of claim 16, wherein the query is selected form a group consisting of a structured query language (SQL) query and a Light Directory Access Protocol query.

18. The system of claim 14, wherein the query message conforms to a Short Message Service (SMS) protocol, and wherein the router provides a response message to the mobile communication device, the response message having the directory information included therein, and the response message conforming to a Short Message Service (SMS) protocol.

19. The system of claim 14, further including:
a billing system in communication with the router, the billing system adapted to charge for looking up the directory information.

20. A mobile communication device, the mobile communication device comprising:
logic embodied in a computer readable medium for generating a query message, the query message including a look-up indicator associated with a missed message; and
logic embodied in a computer readable medium for parsing a response message, the response message including directory information related to the missed message.

21. The mobile communication device of claim 20, further comprising:
logic embodied in a computer readable medium for displaying the directory information to a user of the mobile communication device.

22. The mobile communication device of claim 20, further comprising:
logic embodied in a computer readable medium for saving the directory information in a memory.

23. The mobile communication device of claim 20, wherein the logic for generating the query message further includes:
logic embodied in a computer readable medium for addressing the query message to a predetermined recipient.

24. The mobile communication device of claim 20, wherein the logic for generating the query message further includes:
logic embodied in a computer readable medium for including the look-up indicator in the query message, wherein the look-up indicator is a telephone number.

25. The mobile communication device of claim 20, wherein the logic for generating the query message further includes:
logic embodied in a computer readable medium for providing a return address, wherein the return address identifies the mobile communication device.
